(19) United States
(12) Patent Application Publication
(10) Pub. No.: US 2020/0176729 A1
(43) Pub. Date: Jun. 4, 2020

(54) POWER STORAGE DEVICE

(71) Applicant: Murata Manufacturing Co., Ltd., Nagaokakyo-shi (JP)

(72) Inventor: Yuji Kimura, Nagaokakyo-shi (JP)

(21) Appl. No.: 16/781,210

(22) Filed: Feb. 4, 2020

Related U.S. Application Data
(63) Continuation of application No. PCT/JP2018/030959, filed on Aug. 22, 2018.

(30) Foreign Application Priority Data
Aug. 31, 2017 (JP) 2017-166481

(51) Int. Cl. H01M 2/08; H01M 2/02; H01M 2/16; H01M 10/04; H01M 10/0585

(52) U.S. Cl. CPC H01M 2/08; H01M 2/0207; H01M 2/0275; H01M 10/0585; H01M 2/16; H01M 10/04; H01M 2/0287

(57) ABSTRACT

A power storage device that includes a device body having a negative electrode, a positive electrode, and a separator therebetween; and a package. The package has a shape corresponding to a shape of the device body and accommodates the device body therein. The package includes a first laminate film, a second laminate film, and a sealing material. The first laminate film is on a first side in a laminating direction of the device body. The second laminate film is on a second side in the laminating direction of the device body opposite the first side. The sealing material connects the first laminate film and the second laminate film on a side surface of the device body.

### CROSS REFERENCE TO RELATED APPLICATIONS

The present application is a continuation of International application No. PCT/JP2018/030959, filed Aug. 22, 2018, which claims priority to Japanese Patent Application No. 2017-166481, filed Aug. 31, 2017, the entire contents of each of which are incorporated herein by reference.

### FIELD OF THE INVENTION

The present invention relates to a power storage device.

### BACKGROUND OF THE INVENTION

Conventionally, power storage devices are known as power sources for various electronic devices. For example, Patent Document 1 describes that a laminate in which electrode materials and separator materials are alternately laminated is sealed by thermocompression bonding with a laminator.
Patent Document 1: Japanese Patent Application Laid-Open No. 2015-528629

### SUMMARY OF THE INVENTION

In a power storage device as described in Patent Document 1, the laminate is pressure bonded and sealed with the laminator. Therefore, it is necessary to form at a peripheral edge part of the laminate, a sealing part which has upper and lower laminate films sealed by pressure bonding. This may cause an energy density per unit area of the power storage device to be reduced.

A main object of the present invention is to provide a power storage device having a high energy density per unit area.

A power storage device according to the present invention includes a device body and a package. The device body includes a negative electrode, a positive electrode, and a separator. The separator is between the negative electrode and the positive electrode. The package has a shape corresponding to a shape of the device body and accommodates the device body therein. The package includes a first laminate film, a second laminate film, and a sealing material. The first laminate film is on a first side in a laminating direction of the device body. The second laminate film is on a second side in the laminating direction of the device body opposite the first side. The sealing material connects the first laminate film and the second laminate film on a side surface of the device body.

According to the present invention, the power storage device with the high energy density per unit area can be provided.

### BRIEF EXPLANATION OF THE DRAWINGS

FIG. 1 is a schematic plan view of a power storage device according to a first embodiment.

FIG. 2 is a schematic cross-sectional view taken along a line II-II in FIG. 1.

FIG. 3 is a schematic cross-sectional view of a device body in the power storage device according to the first embodiment.

FIG. 4 is a schematic perspective view seen from an arrow IV in FIG. 1.

FIG. 5 is a schematic plan view of a power storage device according to a second embodiment.

FIG. 6 is a schematic plan view of a power storage device according to a third embodiment.

FIG. 7 is a schematic perspective view seen from an arrow VII in FIG. 6.

FIG. 8 is a schematic plan view of a power storage device according to a fourth embodiment.

FIG. 9 is a schematic plan view of a power storage device according to a fifth embodiment.

FIG. 10 is a schematic cross-sectional view of a part of a power storage device according to a first modification.

FIG. 11 is a schematic cross-sectional view of a part of a power storage device according to a second modification.

FIG. 12 is a schematic cross-sectional view of a part of a power storage device according to a third modification.

### DETAILED DESCRIPTION OF THE INVENTION

Hereinafter, examples of preferred embodiments which implement the present invention will be described. However, the following embodiments are illustrative only. The present invention is not limited to the following embodiments.

Moreover, in each of the drawings referred to in the embodiments and the like, members which substantially have the same function shall be referred to with the same reference symbol. The drawings referred to in the embodiments and the like are schematically described. A dimensional ratio of an object drawn in the drawings may be different from a ratio of dimensions of an actual object.

The dimensional ratio of the object may be different between the drawings. The specific dimensional ratio and the like of the object should be determined in consideration of the following description.

### First Embodiment

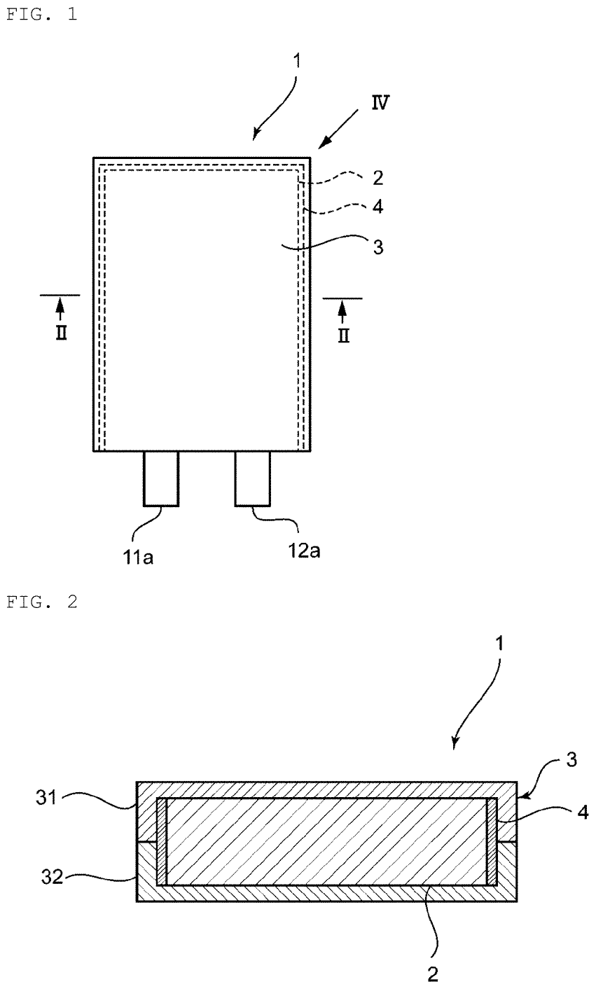

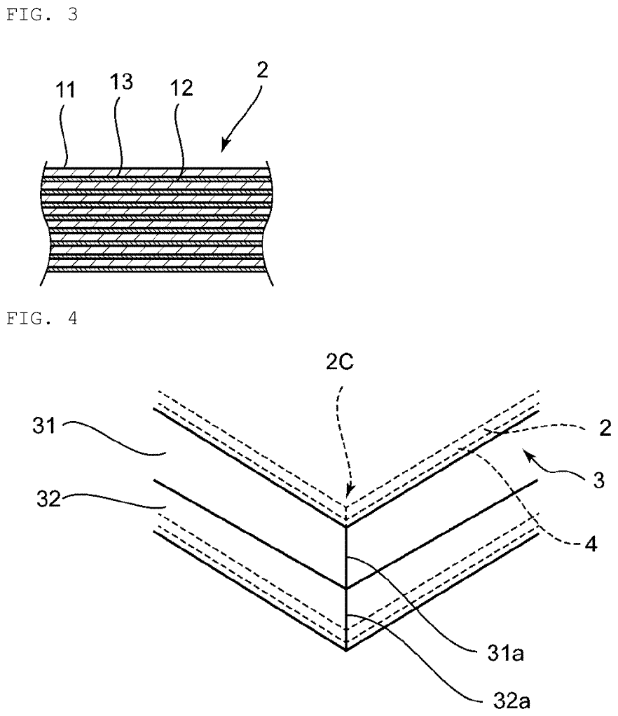

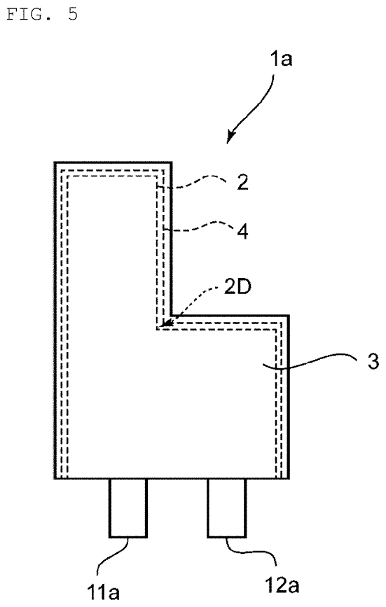

FIG. 1 is a schematic plan view of a power storage device according to a first embodiment. FIG. 2 is a schematic cross-sectional view taken along a line II-II in FIG. 1. FIG. 3 is a schematic cross-sectional view of a device body in the power storage device according to the first embodiment. FIG. 4 is a schematic perspective view seen from an arrow IV in FIG. 1.

The power storage device 1 shown in FIGS. 1 and 2 is not particularly limited as long as it is a device having a power storage function. The power storage device 1 may be, for example, a battery such as a secondary battery, a capacitor such as an electric double layer capacitor, or the like.

As shown in FIG. 2, the power storage device 1 includes a device body 2 and a package 3 accommodating the device body 2.

As shown in FIG. 3, the device body 2 includes a negative electrode 11, a positive electrode 12, and a separator 13. The separator 13 is arranged between the negative electrode 11 and the positive electrode 12. Specifically, the device body 2 is constituted of a laminate in which the negative electrodes 11 and the positive electrodes 12 are alternately laminated with the separators 13 interposed therebetween.

As shown in FIGS. 1 and 2, the device body 2 is accommodated in the package 3. The package 3 has a shape following a shape of the device body 2. The shapes of the device body 2 and the package 3 can be appropriately determined depending on a space in which the power storage device 1 is accommodated. In the present embodiment, the device body 2 and the package 3 have a substantially rectangular shape in plan view.

The package 3 includes a first laminate film 31 and a second laminate film 32.

The first and second laminate films 31 and 32 are not particularly limited as long as at least one main surface thereof is an insulating film. For example, the first and second laminate films 31 and 32 can respectively be constituted of a first resin layer positioned on a side of the device body 2, a metal foil provided on the first resin layer, and a second resin layer provided on the metal foil. The first resin layer can be made of, for example, a resin such as polypropylene. The metal foil is a member for reducing oxygen permeability and moisture permeability of the laminate film. The metal foil can be made of, for example, an aluminum foil or stainless steel foil. The second resin layer can be made of, for example, a resin such as polyethylene terephthalate (PET) or nylon (registered trademark). Note that the first and second laminate films 31 and 32 may be constituted of, for example, a laminate of the first resin layer and the metal foil.

The device body 2 is sealed with the first and second laminate films 31 and 32. The first laminate film 31 is positioned on one side in the laminating direction of the device body 2. On the other hand, the second laminate film 32 is positioned on the other side in the laminating direction of the device body 2. The first and second laminate films 31 and 32 have a larger area than the device body 2.

As shown in FIG. 2, a sealing material 4 is arranged on a side surface of the device body 2. The sealing material 4 is not necessarily provided over the entire circumference of the side surface of the device body 2. As shown in FIG. 1, for example, in the present embodiment, among the side surface of the device body 2, a portion of the side surface from which a negative electrode terminal Ila and a positive electrode terminal 12a are drawn is not provided with the sealing material 4, and a portion of the side surface other than the above portion is provided with the sealing material 4.

The sealing material 4 is preferably made of insulating material having low oxygen permeability and moisture permeability. The sealing material 4 may be made of, for example, a resin such as polypropylene. Further, the sealing material 4 may be constituted of, for example, a laminate of first and second resin layers and a metal layer provided between the first resin layer and the second resin layer. In this case, the first and second resin layers can be made of, for example, polypropylene. The metal layer may be made of, for example, aluminum or stainless steel.

In the present embodiment, as shown in FIG. 2, the sealing material 4 is provided so as to cover the entire side surface of the device body 2 in the laminating direction. However, the present invention is not limited to this configuration. The sealing material may be provided, for example, so as to cover a portion of the side surface of the device body 2 in the laminating direction.

Among the side surface of the device body 2, on the portion of the side surface from which the negative electrode terminal Ila and the positive electrode terminal 12a are not drawn, a peripheral edge part of the first laminate film 31 and a peripheral edge part of the second laminate film 32 are respectively connected to the sealing material 4. Specifically, in the present embodiment, the peripheral edge part of the first laminate film 31 and the peripheral edge part of the second laminate film 32 are respectively bonded to the sealing material 4.

Usually, in the power storage device as described in Patent Document 1, when the device body is sealed with the first and second laminate films, the device body is sealed by being sandwiched and pressure bonded by the first and second laminate films having a larger area than the device body. For this reason, a sealing part is required in which the first and second laminate films overlap without interposing the device body. Therefore, there exists a problem that the energy density per unit area of the power storage device is reduced.

In the power storage device 1, the sealing material 4 for connecting the first laminate film 31 and the second laminate film 32 is provided on the side surface of the device body 2. For this reason, the sealing part of the package 3 can be made small. Therefore, the power storage device 1 in plan view can be reduced in area. Therefore, the energy density per unit area of the power storage device 1 can be increased.

Further, in the power storage device 1, each of the first and second laminate films 31 and 32, and the sealing material 4 are bonded. Accordingly, on the side surface of the device body 2, a portion where the first and second laminate films 31 and 32 are connected are securely sealed by the sealing material 4, so that an electrolyte and the like are difficult to leak, and moisture, oxygen and the like are less likely to enter into the package 3.

From the viewpoint of further downsizing the power storage device 1, as shown in FIG. 2, it is preferable that at least one of the first and second laminate films 31, 32 have bent parts formed by being bent along the side surface of the device body 2 and the bent parts be connected to the sealing material 4. Furthermore, as in the present embodiment, it is preferable that both of the first and second laminate films 31 and 32 have the bent parts that are bent along the side surface of the device body 2 and each of the bent parts are connected to the sealing material 4.

From the same viewpoint, the sealing material 4 is preferably plate-shaped, sheet-shaped, or film-shaped.

In the power storage device 1, an end surface of the bent part of the first laminate film 31 and an end surface of the bent part of the second laminate film 32 are in contact with each other. Therefore, the sealing material 4 is covered with the bent parts, and the sealing material 4 is not substantially exposed. Therefore, the oxygen permeability and moisture permeability of a portion where the sealing material 4 is arranged are lower.

As shown in FIG. 4, the device body 2 has a corner part 2C. The corner part 2C is at the intersection of a first side surface and a second side surface that are adjacent to each other and are covered with the laminate films 31 and 32. The laminate films 31 and 32 have cuts 31a and 32a. The cuts 31a and 32a are provided so as to be positioned on the corner part 2C of the device body 2. With this configuration, the two adjacent bent parts of the first laminate film 31 do not overlap with each other at the corner part 2C. Similarly, the two adjacent bent parts of the second laminate film 32 do not overlap with each other at the corner part 2C. Therefore, the device body 2, and thus the power storage device 1 can be downsized.

Incidentally, when the adjacent bent parts of the laminate film are provided with a cut or notch, it is expected that oxygen and moisture easily enter into the power storage device from this cut or notched portion. However, in the power storage device 1 of the present embodiment, the sealing material 4 is provided across the cut or notch between the adjacent bent parts of the laminate films 31 and 32. Therefore, the entry of oxygen and moisture into the power storage device 1 can be effectively suppressed.

Hereinafter, other examples of preferred embodiments of the present invention are described. In the following description, members having substantially the same functions as those in the first embodiment are referred to with the same reference numerals, and description thereof is omitted.

### Second Embodiment

FIG. 5 is a schematic plan view of a power storage device 1a according to a second embodiment.

In the first embodiment, the example has been described in which the power storage device 1 has a rectangular shape in plan view. However, the present invention is not limited to this configuration. In the present invention, the shape of the power storage device is appropriately determined depending on an arrangement space of the power storage device. For example, as shown in FIG. 5, in the power storage device 1a, the device body 2 has a substantially L-shape having a corner part 2D with an internal angle of 90° or more in plan view. The first and second laminate films 31 and 32 have a cut at a portion positioned at the corner part 2D. The sealing material 4 is provided across the corner part 2D. Each of the bent parts of the first and second laminate films 31 and 32 positioned on both sides of the corner part 2D are connected to the sealing material 4. Therefore, also in the power storage device 1a including the device body 2 having the corner part having the inner angle larger than 90°, the energy density per unit area of the power storage device 1a can be increased as in the power storage device 1. In addition, the entry of oxygen and moisture into the power storage device 1a can be effectively suppressed.

### Third Embodiment

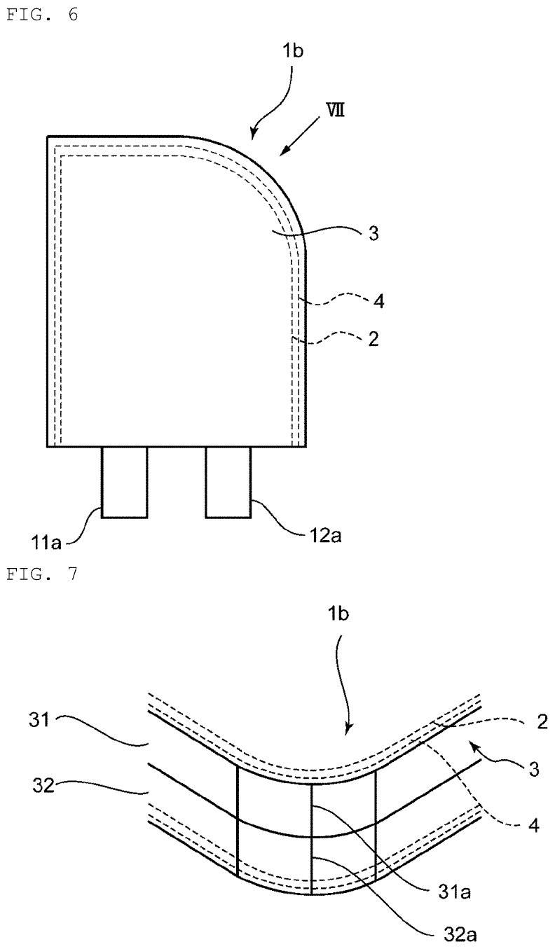

FIG. 6 is a schematic plan view of a power storage device 1b according to a third embodiment.

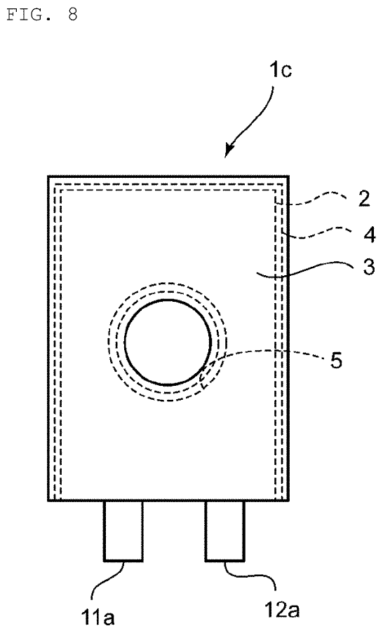

FIG. 7 is a schematic perspective view seen from an arrow VII in FIG. 6.

As shown in FIG. 6, in the power storage device 1b according to the third embodiment, the device body 2 has a side surface that constitutes a curved part in plan view (i.e., a curved side surface). The first and second laminate films 31 and 32 may have one or plural cuts 31a and 32a, respectively, on the side surface constituting the curved part of the device body 2. In this case, in the respective cuts 31a and 32a, it is preferable that the sealing material 4 be provided across the cuts 31a and 32a. Also in the present embodiment, as in the first and second embodiments, the energy density per unit area of the power storage device 1b in plan view can be increased. In addition, the entry of oxygen and moisture into the power storage device 1b can be effectively suppressed.

### Fourth and Fifth Embodiments

FIG. 8 is a schematic plan view of a power storage device 1c according to a fourth embodiment.

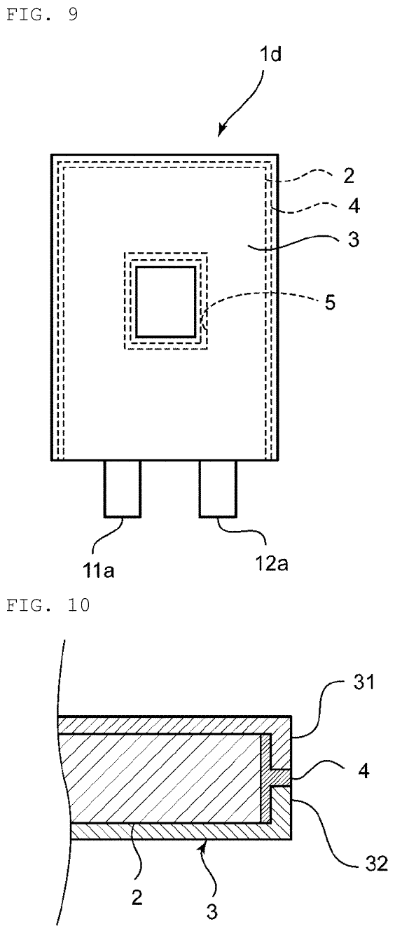

FIG. 9 is a schematic plan view of a power storage device 1d according to a fifth embodiment.

As shown in FIGS. 8 and 9, the power storage devices 1c and 1d each have a through hole penetrating in a thickness direction. Accordingly, the device body 2 also has a through hole 5 that penetrates in the thickness direction. Specifically, the device body 2 of the power storage device 1c has the through hole 5 having a circular shape in plan view. On the other hand, the device body 2 of the power storage device 1d has the through hole 5 having a rectangular shape in plan view.

In the power storage devices 1c and 1d, as in the first embodiment, the sealing material 4 is provided on an outer peripheral surface of the device body 2, and the sealing material 4 is also provided on an inner peripheral surface thereof. Similarly to the outer peripheral surface of the device body 2, the first laminate film 31 and the second laminate film 32 are connected to each other on the inner peripheral surface by the sealing material 4. Specifically, the first and second laminate films 31 and 32 have at least one cuts 31a and 32a, and have bent parts that are bent along the inner peripheral surface. The sealing material 4 connects the first laminate film 31 and the second laminate film 32, and is provided across the cuts 31a and 32a. With this configuration, also in the power storage devices 1c and 1d having the through holes, the energy density per unit area of the power storage devices 1c and 1d can be increased as in the first to third embodiments. In addition, the entry of oxygen and moisture into the power storage devices 1c and 1d can be effectively suppressed.

(First to Third Modifications)

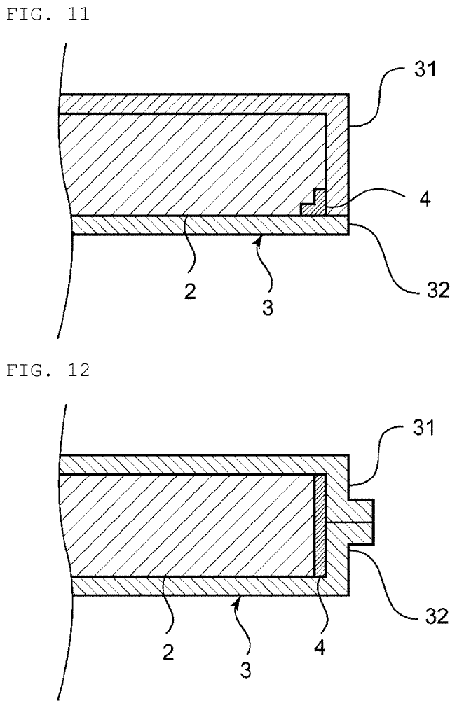

FIG. 10 is a schematic cross-sectional view of a part of a power storage device according to a first modification. FIG. 11 is a schematic cross-sectional view of a part of a power storage device according to a second modification. FIG. 12 is a schematic cross-sectional view of a part of a power storage device according to a third modification.

In the first to fifth embodiments, the example has been described in which both the first and second laminate films 31 and 32 are bent and the end surfaces of both of the laminate films 31 and 32 are in contact with each other. However, the present invention is not limited to this configuration.

For example, as shown in FIG. 10, the end surfaces of both of the laminate films 31 and 32 may be separated from each other, and the sealing material 4 may be provided between the end surface of the first laminate film 31 and the end surface of the second laminate film 32. Further, the end surfaces of both of the laminate films 31 and 32 may be separated from each other, and a space may be formed between the end surface of the first laminate film 31 and the end surface of the second laminate film 32.

For example, as shown in FIG. 11, only the first laminate film 31 may have the bent part. In this case, the sealing material 4 may be provided in a substantially L-shaped cross section across the first laminate film 31 and the second laminate film 32.

For example, as shown in FIG. 12, end parts of the first and second laminate films 31 and 32 may protrude outward from a portion connected to the sealing material 4. In this case, the protruded part may be bent along the side surface of the device body 2. Further, the first laminate film 31 and the second laminate film 32 may be thermocompression bonded at the protruded part.

(Other Modifications)

In the embodiments and the modifications described above, the example has been described in which the sealing material 4 is provided on the side surface of the device body 2. However, the present invention is not limited to this configuration. For example, the sealing material 4 may be provided so as to cover at least a part of the main surface in addition to the side surface, or may be provided so as to cover the device body 2.

A power storage device according to the present invention includes a device body, a package, and a sealing material. The device body includes a negative electrode, a positive electrode, and a separator. The separator is provided between the negative electrode and the positive electrode. The package has a shape corresponding to a shape of the device body. The package accommodates the device body. The package includes a first laminate film, and a second laminate film. The first laminate film is provided on one side in a laminating direction of the device body. The second laminate film is provided on the other side in the laminating direction of the device body. The sealing material connects the first laminate film and the second laminate film on a side surface of the device body.

In the power storage device of the present invention, the sealing material that connects the first laminate film and the second laminate film is provided on the side surface of the device body. Accordingly, the sealing part of the package can be made small. Therefore, the power storage device in plan view can be reduced in area, and the energy density per unit area of the power storage device can be increased.

It is preferable that the sealing material and each of the first and second laminate films be bonded together. In this case, on the side surface of the device body, the portions where the first and second laminate films are connected are securely sealed by the sealing material, so that the electrolyte and the like are difficult to leak, and moisture, oxygen and the like are less likely to enter into the package.

It is preferable that at least one of the first and second laminate films have a bent part that is bent along the side surface of the device body, and the bent part be connected to the sealing material. In this case, the power storage device can be further downsized.

The device body may have a corner part at an intersection of two adjacent side surfaces. In that case, it is preferable that at least one of the first and second laminate films have the cut or notch positioned on the corner part, and the sealing material be provided across the cut or notch. According to this configuration, it is possible to effectively prevent oxygen and moisture from entering the inside of the power storage device.

The inner angle of the corner part may be larger than 90°.

The device body may have a through hole penetrating in the laminating direction, and the corner part may be provided in the through hole.

The device body may have a curved side surface. In that case, at least one of the first and second laminate films may have the cut or notch positioned on the curved side surface, and the sealing material may be provided across the cut or notch.

The device body may have a through hole penetrating in the laminating direction, and the curved side surface may be in the through hole.

### DESCRIPTION OF REFERENCE SYMBOLS

1, 1a, 1b, 1c, 1d: Power storage device
2: Device body
2C, 2D: Corner part
3: Package
4: Sealing material
5: Through hole
11: Negative electrode
11a: Negative electrode terminal
12: Positive electrode
12a: Positive electrode terminal
13: Separator
31: First laminate film
32: Second laminate film
31a, 32a: Cut

1. A power storage device comprising:
a device body having a negative electrode, a positive electrode, and a separator between the negative electrode and the positive electrode; and
a package having a shape that corresponds to a shape of the device body and that accommodates the device body therein, the package including:
a first laminate film on a first side in a laminating direction of the device body,
a second laminate film on a second side in the laminating direction of the device body opposite the first side, and
a sealing material between a side surface of the device body and the first laminate film and the second laminate film, and that connects the first laminate film and the second laminate film on the side surface of the device body.

2. The power storage device according to claim 1, wherein the sealing material and each of the first and second laminate films are bonded to each other.

3. The power storage device according to claim 2, wherein at least one of the first and second laminate films has a bent part that is bent along the side surface of the device body, and the bent part is connected to the sealing material.

4. The power storage device according to claim 1, wherein at least one of the first and second laminate films has a bent part that is bent along the side surface of the device body, and the bent part is connected to the sealing material.

5. The power storage device according to claim 2, wherein each of the first and second laminate films has a respective bent part that is bent along the side surface of the device body, and each of the respective bent parts are connected to the sealing material.

6. The power storage device according to claim 1, wherein each of the first and second laminate films has a respective bent part that is bent along the side surface of the device body, and each of the respective bent parts are connected to the sealing material.

7. The power storage device according to claim 6, wherein a first end surface of the bent part of the first laminate film and a second end surface of the bent part of the second laminate film are in contact with each other.

8. The power storage device according to claim 1, wherein the device body has a corner part at an intersection of two adjacent side surfaces of the device body,
at least one of the first and second laminate films has a cut or notch at the corner part, and
the sealing material is located across the cut or notch.

9. The power storage device according to claim 8, wherein the corner part has an inner angle of greater than 90°.

10. The power storage device according to claim 8, wherein
the device body has a through hole penetrating in the laminating direction thereof, and
the through hole has the corner part.

11. The power storage device according to claim 1, wherein
the device body has a curved side surface,
at least one of the first and second laminate films has a cut or notch on the curved side surface, and
the sealing material is provided across the cut or notch.

12. The power storage device according to claim 11, wherein
the device body has a through hole penetrating in the laminating direction thereof, and
the through hole has the curved side surface.

13. The power storage device according to claim 6, wherein a first end surface of the bent part of the first laminate film and a second end surface of the bent part of the second laminate film are separated from each other, and the sealing material is between the first end surface and the second end surface.

14. The power storage device according to claim 1, wherein only one of the first and second laminate films has a bent part that is bent along the side surface of the device body, and the bent part is connected to the sealing material.

15. The power storage device according to claim 14, wherein the sealing material has an L-shaped cross section.

16. The power storage device according to claim 1, wherein a first end part of the first laminate film and a second end part of the second laminate film protrude outward from portions of the first laminate film and the second laminate film that are connected to the sealing material.

17. The power storage device according to claim 6, wherein a first end part of the first laminate film and a second end part of the second laminate film protrude outward from portions of the first laminate film and the second laminate film that are connected to the sealing material.
